(19) United States
(12) Patent Application Publication
(10) Pub. No.: US 2024/0193570 A1
(43) Pub. Date: Jun. 13, 2024

(54) POINT-OF-SALE TRANSACTION MATCHING METHOD AND SYSTEM

(71) Applicant: Gerardo Ruiz Rocha, San Pedro Garza Garcia (MX)

(72) Inventor: Gerardo Ruiz Rocha, San Pedro Garza Garcia (MX)

(21) Appl. No.: 18/532,024

(22) Filed: Dec. 7, 2023

Related U.S. Application Data
(60) Provisional application No. 63/431,430, filed on Dec. 9, 2022.
(60) Provisional application No. 63/457,486, filed on Apr. 6, 2023.

(51) Int. Cl. G06Q 20/20

(52) U.S. Cl. CPC G06Q 20/20; G06Q 2220/00

(57) ABSTRACT

A simplified, automated, and convenient method and system for tracking, matching, and storing transactions from a point-of-sale (POS) terminal between a customer and any number of merchants. The method and system of matching a POS terminal transaction between a customer and merchant can include generating a first hash based on the received payment information from a user, generating a second hash of the payment information received from a sales transaction at a POS terminal, and performing a search to determine a match between the first hash and the second hash.

### CROSS-REFERENCE TO RELATED APPLICATIONS

This application claims the benefit of U.S. Provisional Application No. 63/431,430, filed on Dec. 9, 2022, which is incorporated herein by reference in its entirety. This application also claims the benefit of U.S. Provisional Application No. 63/457,486, filed on Apr. 6, 2023, which is incorporated herein by reference in its entirety.

### BACKGROUND

This section is intended to introduce the reader to aspects of art that may be related to various aspects of the present disclosure described herein, which are described and/or claimed below. This discussion is believed to be helpful in providing the reader with background information to facilitate a better understanding of the various aspects of the present disclosure described herein. Accordingly, it should be understood that these statements are to be read in this light, and not as admissions of prior art.

In many retail stores or establishments, a point-of-sale (POS) terminal is typically used at a checkout counter in order to process a sales transaction. The transaction between a consumer and a merchant generally occurs at this POS terminal. The POS terminal can act as a credit card terminal where a consumer's credit card can be swiped at the POS terminal or a peripheral device attached to the POS terminal in order to process the transaction. In some of these POS systems, the transaction information (and invoice) can be printed on a physical medium or emailed digital medium. A copy of the receipt (and invoice) can be kept by the store and/or or given to the consumer as well. However, commercial pressure requires the traditional POS terminals and systems to be improved to better serve the customers and the sellers. For example, it can be difficult, inconvenient, and time-consuming for consumers to keep track of all individual printed or digital receipts and invoices, particularly if the consumer wants to keep records of such transactions for potential tax deduction, among other reasons.

Hence, what is needed is a simplified, automated, and convenient system of tracking, matching, and storing all transactions from a POS terminal between a consumer and any number of merchants.

### BRIEF SUMMARY

In one non-limiting exemplary embodiment of the disclosure described herein, a simplified, automated, and convenient method and system is disclosed for tracking, matching, and storing all transactions from a point-of-sale (POS) terminal between a customer and any number of merchants. The method and system of matching a POS terminal transaction between a customer and merchant can include generating a first hash based on the received payment information from a user, generating a second hash of the payment information received from a sales transaction at a point-of-sale terminal, and performing a search to determine a match between the first hash and the second hash.

In another non-limiting exemplary embodiment of the disclosure described herein, a method of matching a transaction between a customer and a merchant is disclosed. The method can include receiving payment information from a first user, wherein the payment information comprises an identifier associated with the first user. In addition, the method can include generating a first hash of the identifier based on the received payment information from the first user and storing the first hash within a repository or database. The method can also include receiving first transaction information at a point-of-sale terminal, wherein the first transaction information comprises the payment information from the first user including the identifier. Further, the method can include generating a second hash of the identifier based on the received transaction information. In addition, the method can include performing a search of the repository or database to identify a match between the first hash and the second hash of the identifier associated with the first user.

Also, the method may include wherein the identifier is a 16-digit credit card number. In addition, the method can include retrieving second transaction information from the point-of-sale terminal. Moreover, the method can include wherein the second transaction information comprises one of more of: a transaction amount, approval number, merchant or establishment number, transaction number, or the last four-digits of the 16-digit credit card number. Further, the method can include generating a first string based on the second transaction information. Also, the method can include generating a third hash of the generated first string. In addition, the method can include receiving the generated third hash, generating a second string based on the second transaction information, generating a fourth hash of the second string, and receiving the generated fourth hash.

In addition, the method can include determining if the third hash matches the fourth hash. Also, the method can include upon determining that the third hash matches the fourth hash, performing a search to identify or locate either the last 4-digits of the identifier or the first or second hash of the identifier to identify or associate a sales transaction with the first user. Further, the method can include upon determining that the first user has been identified, sending a notification that the user has been identified and associating the first or second transaction information with the first user,

In another non-limiting exemplary embodiment of the disclosure described herein a system for matching a transaction between a customer and a merchant, including
a memory storage storing computer-executable instructions; and at least one processor communicatively coupled to the memory storage, wherein the at least one processor is configured to execute the instructions to receive payment information from a first user, wherein the payment information comprises an identifier associated with the first user. Further, wherein the at least one processor can be configured to execute the instructions to generate a first hash of the identifier based on the received payment information from the first user and store the first hash within a repository or database, and receive first transaction information at a pointof-sale terminal, wherein the first transaction information includes the payment information from the first user including the identifier. Also, wherein the at least one processor can also be configured to execute the instructions to generate a second hash of the identifier based on the received transaction information. In addition, the at least one processor can also be configured to execute the instructions to perform a search of the repository or database to identify a match between the first hash and the second hash of the identifier associated with the first user.

In addition, the identifier may include a 16-digit credit card number. Further, the at least one processor may be configured to execute the instructions to retrieve second transaction information from the point-of-sale terminal. Also, the second transaction information can include one or more of: a transaction amount, approval number, merchant or establishment number, transaction number, and the last four-digits of the 16-digit credit card number. Also, the at least one processor may be configured to execute the instructions to generate a first string based on the second transaction information. In addition, the at least one processor may be configured to execute the instructions to generate a third hash of the generated first string. Further, the at least one processor may be configured to execute the instructions to receive the generated third hash, generate a second string based on the second transaction information, generate a fourth hash of the second string, and receive the generated fourth hash.

Further, the at least one processor may be configured to execute the instructions to determine if the third hash matches the fourth hash. In addition, the at least one processor may be configured to execute the instructions to upon determining that the third hash matches the fourth hash, perform a search of the repository to identify either the last 4-digits of the identifier or the first or second hash of the identifier.

In another aspect of the disclosure described herein, a non-transitory computer-readable recording medium having recorded thereon instructions executable by at least one processor to cause the at least one processor to perform a method for matching a transaction between a customer and a merchant, including receiving payment information from a first user, wherein the payment information comprises an identifier associated with the first user. The method can further include generating a first hash of the identifier based on the received payment information from the first user and storing the first hash within a database, and receiving first transaction information at a point-of-sale terminal, wherein the first transaction information comprises the payment information from the first user including the identifier. The method can also include generating a second hash of the identifier based on the received transaction information, and performing a search of the database to identify a match between the first hash and the second hash of the identifier associated with the first user.

The above summary is not intended to describe each and every disclosed embodiment or every implementation of the disclosure. The Description that follows more particularly exemplifies the various illustrative embodiments.

### BRIEF DESCRIPTION OF THE DRAWINGS

The following description should be read with reference to the drawings, in which like elements in different drawings are numbered in like fashion. The drawings, which are not necessarily to scale, depict selected embodiments and are not intended to limit the scope of the disclosure. The disclosure may be more completely understood in consideration of the following detailed description of various embodiments in connection with the accompanying drawings, in which:

FIG. 1 illustrates a simplified diagram for a general network architecture for the point-of-sale (POS) transaction matching method and system of the disclosure described herein, according to one non-limiting exemplary embodiment.

FIG. 2 illustrates a simplified diagram for another general network architecture and process for the POS transaction matching method and system of the disclosure described herein, according to one non-limiting exemplary embodiment.

FIG. 3 illustrates a flowchart diagram for a user/customer credit card enrollment process of the POS transaction matching method and system of the disclosure described herein, according to one non-limiting exemplary embodiment.

FIG. 4 illustrates a flowchart diagram for a sales transaction and metadata generation process at a POS terminal of the POS transaction matching method and system of the disclosure described herein, according to one non-limiting exemplary embodiment.

FIG. 5 illustrates a flowchart diagram for a sales transaction search and match process of the POS transaction matching method and system of the disclosure described herein, according to one non-limiting exemplary embodiment.

FIG. 6 illustrates a flowchart diagram for another general network architecture for the POS transaction matching method and system of the disclosure described herein, according to one non-limiting exemplary embodiment.

FIG. 7 illustrates a graphical user interface (GUI) portal of a card registration process, according to one non-limiting exemplary embodiment.

### DETAILED DESCRIPTION

In the Brief Summary of the present disclosure above and in the Detailed Description of the disclosure described herein, and the claims below, and in the accompanying drawings, reference is made to particular features (including method steps) of the disclosure described herein. It is to be understood that the disclosure of the disclosure described herein in this specification includes all possible combinations of such particular features. For example, where a particular feature is disclosed in the context of a particular aspect or embodiment of the disclosure described herein, or a particular claim, that feature can also be used, to the extent possible, in combination with and/or in the context of other particular aspects and embodiments of the disclosure described herein, and in the disclosure described herein generally.

The embodiments set forth below represent the necessary information to enable those skilled in the art to practice the disclosure described herein and illustrate the best mode of practicing the disclosure described herein. In addition, the disclosure described herein does not require that all the advantageous features and all the advantages need to be incorporated into every embodiment of the disclosure described herein.

In one implementation of the disclosure described herein, a display page may include information residing in the computing device's memory, which may be transmitted from the computing device over a network to a central database center and vice versa. The information may be stored in memory at each of the computing device, a data storage resided at the edge of the network, or on the servers at the central database centers. A computing device or mobile device may receive non-transitory computer readable media, which may contain instructions, logic, data, or code that may be stored in persistent or temporary memory of the mobile device, or may somehow affect or initiate action by a mobile device. Similarly, one or more servers may communicate with one or more mobile devices across a network, and may transmit computer files residing in memory. The network, for example, can include the Internet, wireless communication network, or any other network for connecting one or more mobile devices to one or more servers.

Any discussion of a computing or mobile device may also apply to any type of networked device, including but not limited to mobile devices and phones such as cellular phones (e.g., an iPhone®, Android®, Blackberry®, or any “smart phone”), a personal computer, iPad®, server computer, or laptop computer; personal digital assistants (PDAs); a roaming device, such as a network-connected roaming device; a wireless device such as a wireless email device or other device capable of communicating wireless with a computer network; or any other type of network device that may communicate over a network and handle electronic transactions. Any discussion of any mobile device mentioned may also apply to other devices, such as devices including Bluetooth®, near-field communication (NFC), infrared (IR), and Wi-Fi functionality, among others.

Phrases and terms similar to “software”, “application”, “app”, and “firmware” may include any non-transitory computer readable medium storing thereon a program, which when executed by a computer, causes the computer to perform a method, function, or control operation.

Phrases and terms similar “network” may include one or more data links that enable the transport of electronic data between computer systems and/or modules. When information is transferred or provided over a network or another communications connection (either hardwired, wireless, or a combination of hardwired or wireless) to a computer, the computer uses that connection as a computer-readable medium. Thus, by way of example, and not limitation, computer-readable media can also comprise a network or data links which can be used to carry or store desired program code means in the form of computer-executable instructions or data structures and which can be accessed by a general purpose or special purpose computer.

Phrases and terms similar to “portal” or “terminal” may include an intranet page, internet page, locally residing software or application, mobile/computing device graphical user interface, or digital presentation for a user. The portal may also be any graphical user interface for accessing various modules, features, options, and/or attributes of the disclosure described herein. For example, the portal can be a web page accessed with a web browser, mobile/computing device application, or any application or software residing on a computing device.

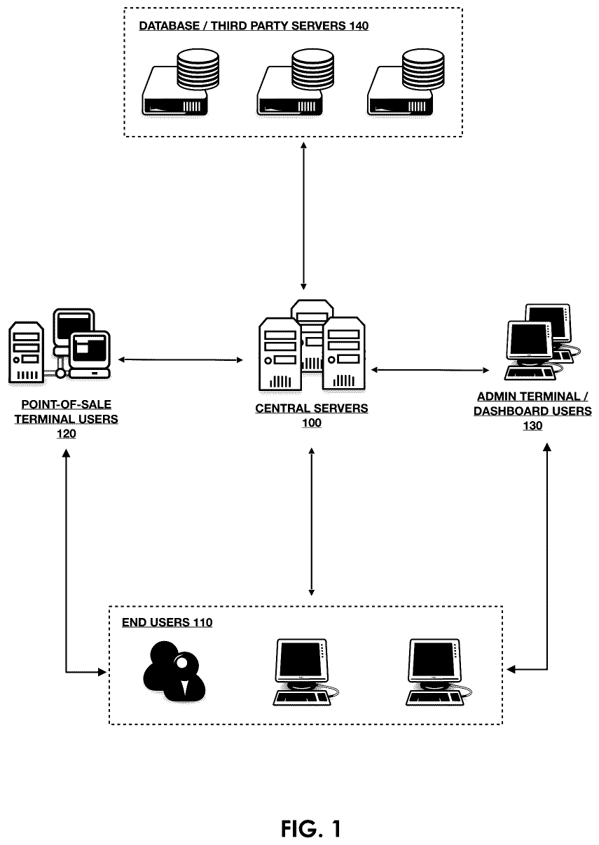

FIG. 1 illustrates a diagram of a general network architecture according to one or more embodiments of the disclosure described herein. Referring to FIG. 1, end users 110 (e.g., clients/customers), point of sale terminal users 120 (e.g., merchants), and admin terminal/dashboard users 130 (collectively referred to herein as users 110, 120, and 130) can be in bi-directional communication over a secure network with central servers or application servers 100 according to one or more embodiments. In addition, users 110, 120, 130 may also be in direct bi-directional communication with each other via the network system of the disclosure described herein according to one or more embodiments. In particular, users 110 (e.g., customers) can be in direct communication with POS terminal users 120 (e.g., merchants) such as for facilitating a credit card sales transaction for one or more goods or services. Here, users 120 can be operating POS terminals at their location in communication with servers 100 of the network system, or the POS terminals (and related software) may be operated on or via servers 100 or third-party servers 140. Here, users 110 can be any type of customer, buyer, or vendor of a retail store, merchant, or establishment, such as users operating computing devices and user terminals. Each of users 110 can communicate with servers 100 via their respective terminals or portals, wherein servers 110 can provide or automatically operate and facilitate the POS transaction matching method and system of the disclosure described herein (and be in further communications with POS terminals. Users 120 can include the merchants, retailer, seller, application development members or support agents of the merchant, vendors, POS terminal computing device operator, credit card processor, gateway processor, payment processor, agents, any POS terminal, or any user using a POS terminal to facilitate a sales transaction of the POS transaction matching network of the disclosure described herein, including providing support services to end users 110 (e.g., customers).

Still referring to FIG. 1, admin terminal/dashboard users 130 may be any type of user with access privileges for accessing a dashboard or management portal of the disclosure described herein, wherein the dashboard portal can provide various user tools, transaction histories, transaction patterns, maps, open/closed/pending support tickets, graphs, and other customer or merchant support options. It is contemplated within the scope of the present disclosure described herein that any of users 110 and 120 may also access the admin terminal/dashboard 130 of the disclosure described herein.

Still referring to FIG. 1, central servers 100 of the disclosure described herein according to one or more embodiments can be in further bi-directional communication with database/third party servers 140, which may also include users. Here, servers 140 can include vendors and databases where various captured, collected, or aggregated data, such as customer/merchant information, transactions, receipts, invoices, monitoring, troubleshooting, and performance data may be stored thereon and retrieved therefrom for by servers 100. Servers 140 may also include user registration information and a repository/database for storing user's hashed/encrypted credit card or payment information. However, it is contemplated within the scope of the present disclosure described herein that the POS transaction matching method and system of the disclosure described herein can include any type of general network architecture.

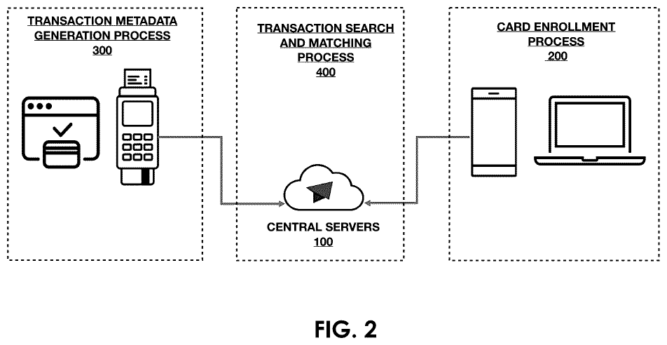

FIG. 2 illustrates one non-limiting exemplary embodiment of a general network architecture and process for the POS transaction matching method and system of the disclosure described herein. In particular, central servers 100 (or back-end servers) of the POS transaction matching system can receive a customer, client, or user's payment/credit card data via either a web portal or an application on a user's mobile/computing device, wherein the credit card data is encrypted/hashed via servers 100 (or by an application on the user's computing device) on stored in a repository. The card enrollment process 200 will be described later in more detail within the disclosure. In addition, central servers 100 can also receive hashed/encrypted transaction metadata information (including hashed/encrypted credit card information) from a merchant's POS terminal. The transaction metadata generation process 300 will also be described later in more detail within the disclosure. Further, a transaction search process 400 is also performed via servers 100, which is to also be discussed in more detail later, that can match hashed credit card and customer information (received from the user/customer) with that of hashed credit card and transaction information received from the merchant.

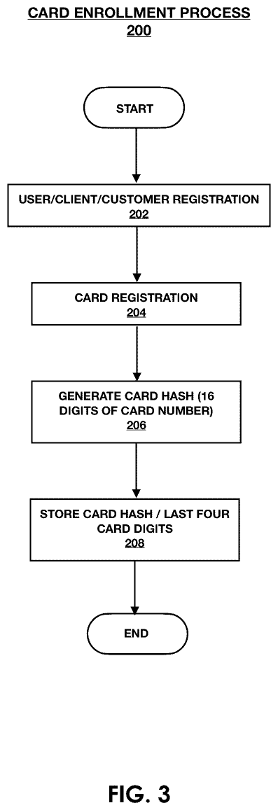

FIG. 3 illustrates one non-limiting exemplary embodiment of a process for enrolling a credit card to the network system of the disclosure described herein via a user/customer/client. Here, the card enrollment process 200 can start at step 202, wherein the user, client, buyer, or customer can register with the POS transaction matching system or network of the disclosure described herein, such as by creating a profile that can include usernames/passwords associated with an account and other related user data. Next, at step 204, the user can register his/her credit card payment information with the POS transaction matching system by including all of his/her credit card information, such as the name on the card, expiration date, 16-digit credit card number (or any credit card identification number or identifier), security or PIN code, and billing address for the credit card. Here, it is contemplated within the scope of the present disclosure described herein that any payment information or payment identifier may be registered and hashed by the POS transaction method and system of the disclosure described herein, such as credit card information (such as 16-digit card numbers), eChecks (bank account/routing information and values), cryptocurrencies, and cryptocurrency wallet accounts/address, cryptocurrency secret/private keys, or any fiat or non-fiat currency, among others.

Still referring to FIG. 3, next, at step 206, the POS transaction matching system can automatically generate a hashed (encrypted) string value of the user's 16-digit credit card number via a hash function, such as the HMAC-SHA256 encryption algorithm or any other encryption algorithm, such as via the code shown below in one exemplary embodiment:

```
public static string EncryptHMACSHA256(string entry, string
secret)
{
  var key = Encoding.Default.GetBytes(secret);
  var input = Encoding.Default.GetBytes(entry);
  using HMACSHA256 hmac = new(key);
  return Convert.ToBase64String(hmac.ComputeHash(input));
}
```

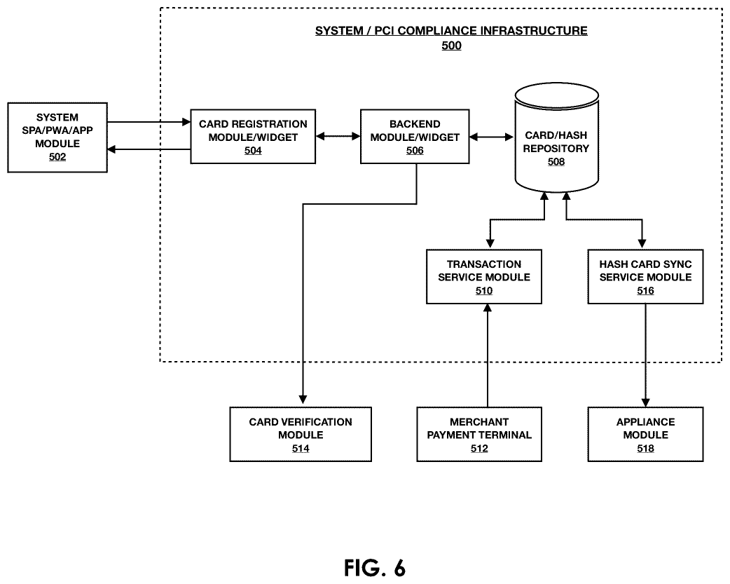

Still referring to FIG. 3, at step 208, the first generated hashed (encrypted) string of the user's 16-digit credit card in addition to the last 4-digits of the credit card number can then be stored by the POS matching system of the disclosure described herein, such as within a hash database or repository, such as repository 508 shown in FIG. 6. This first generated hashed string of the 16-digit card number and last 4-digit credit card number of the user can then be used by the system of the disclosure described herein to match it with a hashed string of the user's credit number received from a merchant's POS computing device or terminal.

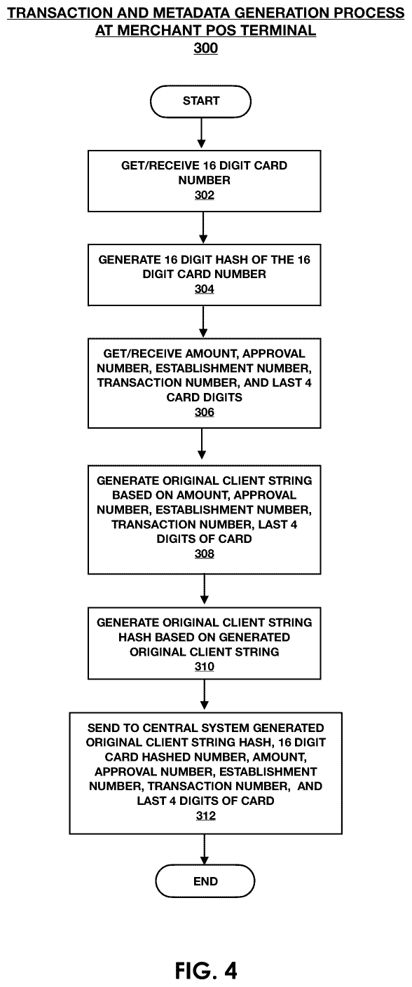

FIG. 4 illustrates one non-limiting embodiment of a process of generating a second hashed value of the user's 16-digit number at a merchant's POS terminal, among other processes. Here, it is contemplated within the scope of the present disclosure described herein that any number of POS terminals or POS computing devices can be programmed to execute the transaction metadata generation process 300 of the disclosure described herein, or include software, firmware, or logic installed thereon incorporating process 300 of the disclosure described herein. Here, process 300 can start at step 302, wherein the POS terminal can obtain, get, or receive the user's 16-digit credit card number (previously encrypted/hashed and stored with the network system per FIG. 3). Next, at step 304, the POS terminal can generate a second hashed/encrypted string of the user's 16-digit credit card, wherein the values within the second hashed string of the credit card number are identical to that of the first hashed string of the credit card number from step 206 of FIG. 3.

Still referring to FIG. 4, at step 306, the merchant's POS terminal can obtain, get, receive, and/or record additional information from the user/customer/client, such as the following parameters: (1) the amount paid by the user for the transaction (and/or items or services purchased), (2) an approval code or number for the transaction, (3) the number or code of the retail establishment or merchant wherein the transaction took place (including its location, address, tax ID, business registration ID, or coordinates), (4) the transaction code or number (such as a transaction ID associated with the transaction), and (5) the last 4-digits of the user's credit card used for the transaction. Next, at step 308, optionally, the process can concatenate and generate a first unencrypted client string based any one or more of the foregoing parameters items (1)-(5) (which can be used for validation purposes). Next, at step 310, optionally (if step 306 is performed), the POS terminal can generate a first hashed (encrypted) client string based on the first unencrypted client string using a hash function, such as the same hash function or algorithm of prior steps 206 or 304. Next, at step 312, the POS terminal can then send the following information to the central network system or one or more servers of the disclosure described herein, such as servers 100: (a) the second hashed string from step 304, (b) optionally, the first hashed client string from step 310, and (c) any one or more of the aforementioned parameters (1)-(5) from step 306 (which may be unencrypted or optionally encrypted/hashed).

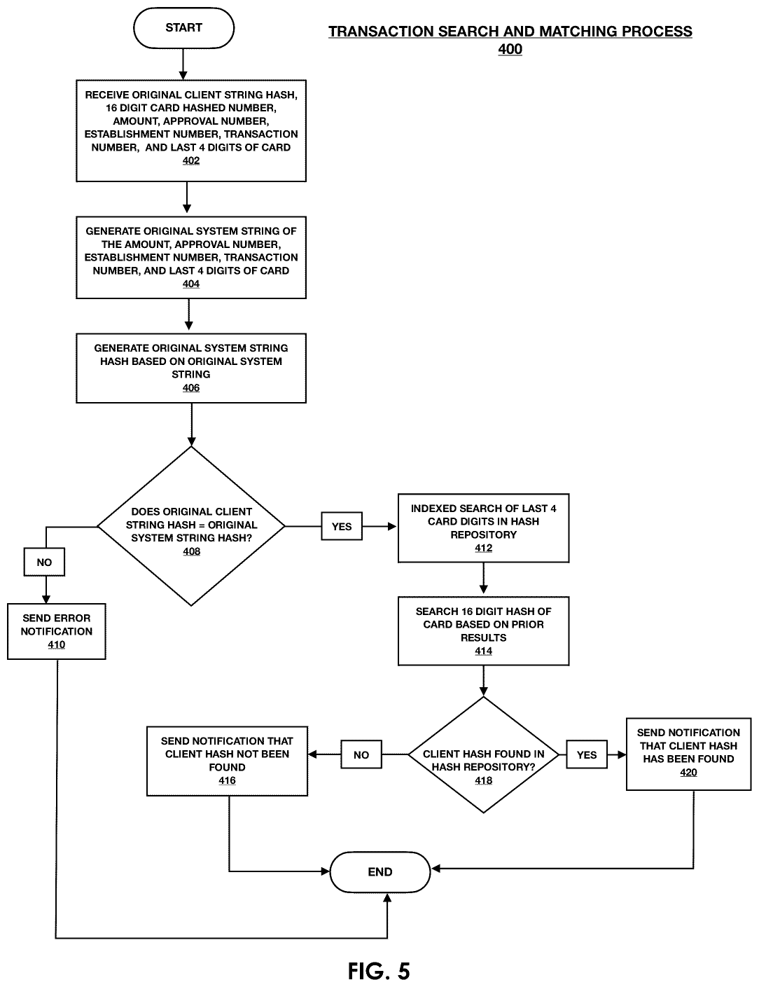

FIG. 5 illustrates one non-limiting embodiment of a sales transaction search and matching process flow of the disclosure described herein. Here, once servers 100 of the disclosure described herein have received information from the user (via process 200) and transaction information from the merchant/POS terminal (via process 300), then process 400 can operate to automatically search and match the transactions with the user's profile previously created with the system of the disclosure described herein. In particular, process 400 can start at step 402, wherein the central system receives (a) the second hashed client string from step 304, (b) optionally the first hashed client string from step 310, and (c) any one or more previously discussed parameters (1)-(5) from step 306 (which may be unencrypted or optionally encrypted).

Still referring to FIG. 5, at step 404, optionally, the central system can then concatenate or generate a second unencrypted client string (original system string) that includes any one or more of received aforementioned parameters (1)-(5) from step 306. Next, at step 406, optionally, the system can generate via a hash function (such as the same has function of step 310) a second hashed client string (original system string hash) based on the generated second unencrypted client string (original system string) from step 404. Next, at step 408, the system can then perform a comparator or comparing operation in order to find an exact match between the first hashed client string (original client string hash) of step 310 with that of the second hashed client string (original system string hash) of step 406. In the event that no match is found, the system can generate a notification error to the user/merchant and/or terminate the search process at step 410. In the event that a match is found, then the process of the central system can proceed to step 412. At step 412, the process of the central system can further include performing an indexed search of the last 4-digits of the user's card received in step 402 to determine if there is a match with the last 4-digits of the user's card received at step 208 within the card/hash repository or database 508 (FIG. 6). Next, at step 414, the system can perform a search (in series or in parallel with step 412) of the user's hashed 16-digit card number received in step 402 to determine if there is a match of the hashed values with the user's hashed 16-digit card number received at step 204 within the card/hash repository or database 508. Next, at step 418, the system can determine if the information from step 412 and 414 were found or identified (either one or both), and if no, then the system can send a notification to the user that the transaction could not be matched, and if yes, then the system can send a notification to the user that a match was found (and/or store the match and transaction information). It is contemplated within the scope of the present disclosure described herein that, preferably, the central system can perform both the last 4-digit (unencrypted) search and encrypted 16-digit hash search in order to ensure accuracy in matching a client/customer/user with each of their transactions; however, it is also contemplated within the scope of the present disclosure described herein that process of the central system can also perform either of steps 412 or 414.

Still referring to FIG. 5, once a match is found, then the user/customer can login to the POS matching system of the disclosure described herein in order to view the matched sales transaction, including the receipt, amount, invoice, transaction time/date, card used, merchant name/location information, historical transaction data, and other pertinent information. Further, such information can be presented to the user via a simple and convenient graphical user interface portal in which the user view all prior transactions, purchase history, and tax reports and/or potential tax deductions related to each purchase (wherein such deduction amounts can also be auto-generated or auto-calculated), and auto-classify certain transactions as either being tax deductible or not, among other advantages. Here, it is contemplated within the scope of the present disclosure described herein that various types of data analysis can be performed with respect to each match, such as via machine learning or artificial intelligence, in order to provide useful feedback to the clients/customers/users and/or merchants. Further, the central system and portal may provide functionality for a user to automatically submit transaction information with merchants to one or more government or third-party agencies. In addition, it is contemplated within the scope of the present disclosure described herein that third parties (and/or the merchants) may also market their products/services to the user based on their transaction history with a particular merchant or a good/service.

FIG. 6 illustrates another general network architecture for the disclosure described herein. Here, the card matching system of the disclosure described herein can include a Payment Card Industry (PCI) compliant card information management service network infrastructure 500 (operated by the network system of the disclosure described herein) which can enable users/customers to register their bank/credit cards. This information may then be searched to determine if a card with which a particular transaction has been made is registered with a credit card information database (such as repository 508) of the system's users/customers/clients. In general, the architecture may include a card registration module/widget 504 that communicates with an application programming interface (API), part of which can be exposed for integration with external applications, such as with the system's application/module 502. Here, module 502 which can include a single page application (SPA) or a progressive web application (PWA), among other types of applications, such as applications residing on mobile computing devices. In addition, an appliance module 518 (hosted by a payment Aggregator's infrastructure, such as on servers) for communicating with merchant POS terminals and can be used to allow a PCI payment Aggregator to have a copy of the card data in a local environment in order to validate if a given card is registered with the network system of the disclosure described herein, without having to send sensitive/private information to an external solution.

Still referring to FIG. 6, the card matching system can include an external application 502 (having a terminal/portal hosted by the network system or locally residing on a user's mobile or computing de device) for communicating bi-directionally with card registration widget/module 504, wherein application 502 can send hashed user credit card data to widget 504 via a token/authorization tool or interface (such as previously described with respect to FIG. 2) to be stored in the card/hash repository 508. In addition, a widget/module 504 that can send hashed credit card data (such as the last 4-digits or card and hashed 16-digit number) back to application 502. Here, card registration widget/module 504 may also communicate bi-directionally with a backend widget/module 506, wherein module 506 can communicate bi-directionally with a card verification service module 514 for verifying credit card data. In addition, backend widget/module 506 may communicate bi-directionally with a card/hash repository database 508, which can store various card information, such as the hash of the 16-digit card number, expiration date, and last 4-digits of the user's card. In addition, database 508 may be in bi-directional communication with a transaction service module 510 which can receive and process transaction information related to a user's card from a merchant's payment terminal 512 (such as a POS terminal). In addition, database 508 may be in bi-directional communication with a Hash Card Synchronization services module 516 which can receive and process synchronization requests from appliance module 518, such that data stored in database 508 is continuously synchronized with the most up-to-date information. Here, transaction information may be sent from terminal 512 to infrastructure 500 for the card matching processes disclosed herein.

Still referring to FIG. 6, alternatively, or in addition to, the card matching system and application of the disclosure described herein can include a software stack configuration or module that may include, for exemplary purposes, frontend Angular+Ng-Zorro system 504, backend system 506 having a .NET 6 system, database 508 including Azure SQL, infrastructure 500 including Azure PCI Compliance, and one or more appliances/modules with a backend in C #and PostgreSQL. In addition, the card matching system and application of the disclosure described herein can include an authentication module wherein the widgets and the integration of the API can be protected resources.

In addition, the card matching system and application of the disclosure described herein can include a confirmation module. Here, the confirmation module can confirm whether an operation performed by a Representational State Transfer (REST) Web Services module was successful or not. In particular, the following http protocol status codes could be returned in response, namely, a code 200 for indicating that the transaction or query was successful, and/or a code 201 for indicating that a newly created information record was successfully created, among others. In the alternative, if there is an error in a request made to the REST Web Services, the following http protocol status codes can be returned in response, namely: a code 400 for indicating that an error occurred in validation of information and/or business rules; a code 401 for indicating that an error occurred while authenticating the requesting user; a code 404 for indicating that a requested information item was not found; a code 422 indicating that a structure of the model for the request made is invalid; and/or a code 500 indicating that an unexpected error has occurred.

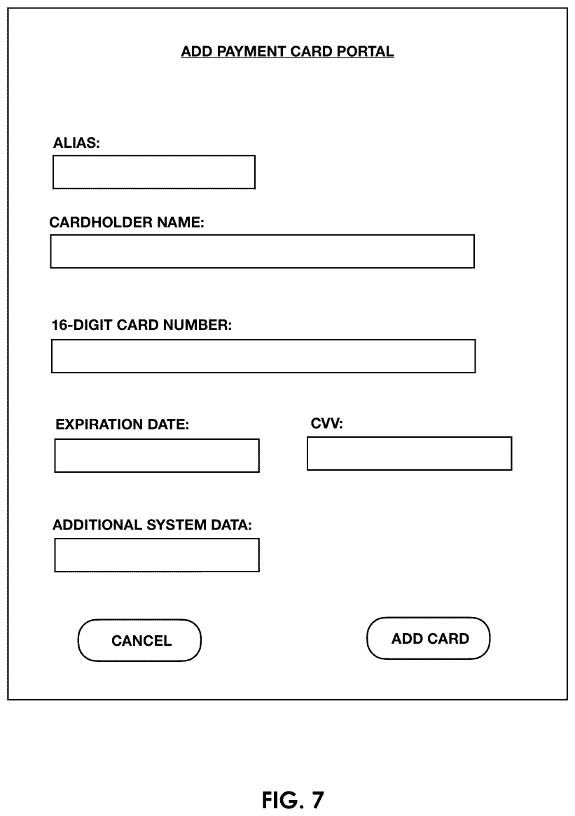

Further, the card matching system of the disclosure described herein can include the card registration widget or portal, such as shown in FIG. 7, for registering a user's credit car or payment information with the system of the disclosure described herein, including an alias, cardholder name, 16-digit credit card number (which can be hashed/encrypted), expiration date, CVV, and any additional system or user data. Here, the card registration widget or module 504 can be an Angular Widget component that allows an end user to register, query, and delete cards. The widget can include various types of security and user/data authentication as well. With respect to card registration, a user can capture and enter basic information from a card to be registered with the system of the disclosure described herein using the input/output data shown in TABLE 1. In addition, the system may include a card verification process as well.

TABLE 1

| Name | Type | I/O | Required | Description |
|---|---|---|---|---|
| CardNumber | String | Input | Required | Card number to |
| | | | | be registered. |
| ExpirationDate | Date | Input/ | Required | Card expiration |
| | | Output | | date. |
| CardVerifica- | String | Input | Required | Card CCV/CVC. |
| tionCode | | | | |
| Id_Card | UUID | Output | Required | ID created on |
| | | | | successful card |
| | | | | registration to be |
| | | | | used in future |
| | | | | transactions. |
| LastFourDigits | String | Output | Required | Last 4 digits |
| | | | | from credit card |
| | | | | number. |
| CardType | String | Output | Required | Mastercard, Visa, |
| | | | | AmEx etc. |

In addition, TABLE 2 shows certain information that may be stored within a database (such as in database 508) of the system of the disclosure described herein.

TABLE 2

| Name | Type | Required | Description |
|---|---|---|---|
| ExpirationDate | Date | Required | Card expiration date. |
| CardHash | String | Required | HMAC SHA 256 |
| | | | Hash calculated from |
| | | | card number and a |
| | | | given secret key. |
| LastFourDigits | String | Required | Last 4 digits from |
| | | | credit card number. |
| Id_Card | String | Required | Card unique ID. |

Here, if the card registration process is successful, a Universal Unique Identifier (UUID) can be assigned to the registered card and the UUID then returned to the system of the disclosure described herein.

With respect to card deletion, a user can request for a card to be deleted upon receiving such a request or query, such as shown in TABLE 3. Upon such a request, card information can be physically deleted from a database of the system, and the system can be notified of such a deletion.

TABLE 3

| Name | Type | I/O | Required | Description |
|---|---|---|---|---|
| Id_Card | String | Input | Required | Card ID to delete. |

In addition, the card matching system of the disclosure described herein includes a card match service, which can include three different types of processes, namely: a first process whereby card matching is performed directly within the system of the disclosure described herein via one or more API's, such as disclosed with respect to FIG. 2 and FIG. 5; a second process whereby card matching is performed within an Appliance where a card database is replicated; and a third process whereby card matching is performed by a user or client payment terminal (such as a POS terminal) that uses the system of the disclosure described herein, wherein a database registry (initial loading and deltas) can be sent with a JSON file to the POS terminal or back to the central system of the disclosure described herein.

With respect to the first process, the system can first check if a card used in a transaction is registered with the system, via a POST request shown in TABLE 4. Here, the responses to the below strings can be the disclosed codes 200, 400, 401, 404, 422, and/or 500, also shown in TABLE 5.

TABLE 4

| Name | Type | Required | Description |
|---|---|---|---|
| cardHash | string | Required | Hash of |
| | | | (16 card digits) |
| originalStringHash | string | Optional | Hash of |
| | | | (totalAmount\|approval- |
| | | | Number\| establish- |
| | | | mentNumber\|transac- |
| | | | tionNumber\|lastFour- |
| | | | Digits) |
| totalAmount | double | Optional | Amount of the sale |
| | | | operation |
| approvalNumber | string | Optional | Payment approval |
| | | | identifier |
| establishmentId | string | Required | Establishment |
| | | | identifier |
| TransactionNum- | string | Required | Transaction identifier |
| ber | | | |
| lastFourDigits | string | Required | Last four digits of the |
| | | | card |

TABLE 5

| Name | Type | Required | Description |
|---|---|---|---|
| Id_Card | String | Optional | Identifier of |
| | | | the bank card |
| requestId | string | Required | Request Identifier |

As discussed, the first process can include the process previously disclosed with respect to FIG. 5. Alternatively, or in addition, the first process can include the following steps: Step 1) wherein the matching process of the disclosure described herein can receives from a user's device, the following: a string with a hash value that corresponds to the 16 digits of the user's card, a string with a hash value that corresponds to the original string generated on the client device, the amount of a transaction, an approval number of the transaction, an identifiable number for the establishment where the transaction took place, a transaction number, and the last 4 digits of the card with which the transaction was made; Step 2) wherein optionally the amount of the transaction, the approval number of the transaction, the number of the establishment where the transaction was made, the transaction number and the last 4 digits of the card with which the transaction was made can then be concatenated to generate an original chain of the transaction; Step 3) wherein optionally from the original generated string and through applying a hash function, a string is generated with the hash value that corresponds to the original string generated in the previous step; Step 4) optionally the string with the hash value that corresponds to the original string sent by the user's device, is compared against the string with the hash value that corresponds to the original string generated in the previous step and Step 4a) if the values of Step 4 are not equal, a notification is sent with respect to an error in the process or Step 4b) if the values of Step 4 are equal, then the process can continue; Step 5) based on the last 4 digits of the card, the indexed search is performed in a hash repository; Step 6) a search is performed on the previous result of the hash of the 16 digits of the card; and Step 6a) if the hash is not found in the search from Step 6, a notification of non-identification is sent to the system or Step 6b) if the hash of Step 6 is found in the search, a notification for the identification of the hash is sent to the system.

With respect to the second and third processes, the card matching system of the disclosure described herein can include an updated card download request service for the appliance, namely, a request to download the card data with updates in a provided date range, via a POST request. Here, the request body can include the following parameters shown in TABLE 6. Responses to the foregoing request can include the disclosed codes 200, 400, 401, 404, 422, and/or 500, and information shown in TABLE 7. An additional GET request may also be sent/initiated, for returning the details of the request, which can include the disclosed codes 200, 401, 404, 500, and information shown in TABLE 8.

TABLE 6

| Name | Type | Required | Description |
|---|---|---|---|
| startDate | date | Required | Start date of the time period for |
| | | | which updates are required |
| endDate | date | Required | End date of the time period for |
| | | | which updates are required |

TABLE 7

| Name | Type | Required | Description |
|---|---|---|---|
| requestId | string | Required | Request Identifier |

TABLE 8

| Name | Type | Required | Description |
|---|---|---|---|
| requestId | string | Required | Request Identifier |
| status | short | Required | (1-Requested, 2-In process, 3-Ready, |
| | | | 4-Expired) |
| expiration | date | Optional | Request expiration date. 12 hours |
| | | | after it is ready. |
| urlFiles | string [ ] | Optional | Array of file download URLs. Files |
| | | | are deleted when the request expires. |
| num- | short | Optional | Number of request files |
| berFiles | | | |

The card matching system of the disclosure described herein can also include a data integrity check module. Here, when data is synchronized, there can be an optional health check in order to ensure data integrity between the container and a database of the disclosure described herein, wherein a POST request can be shown in TABLE 9. The responses to the foregoing request can include the disclosed codes 200, 400, 401, 404, 422, and/or 500, and further shown in TABLE 10.

TABLE 9

| Name | Type | Required | Description |
|---|---|---|---|
| DBHash | String | Required | Hash of the entire local DB |
| | | | to be compared |

TABLE 10

| Name | Type | Required | Description |
|---|---|---|---|
| DbMatch | boolean | Required | If false, databases do not match. |

Further, the card matching system of the disclosure described herein can include a card data software appliance. The card data software appliance component can be PCI compliant. This component can store a local copy of the card data, as shown in TABLE 11.

TABLE 11

| Name | Type | Required | Description |
|---|---|---|---|
| cardHash | String | Required | HMAC SHA 256 Hash calculated |
| | | | from card number and a given |
| | | | secret key. |
| lastFourDigits | Short | Required | Last 4 digits from bank card |
| | | | number. |
| updatedDate | Date | Required | Card update date. |
| Id_Card | String | Required | Card unique identifier |

Here, for the synchronization of the card data, the following process can be is carried out periodically, namely: a card update download service process can be invoked, which returns a request id that is registered as pending; here, if there is a pending request, it asks about the status of the request, and if the status is “Ready”, the download URLs of updated card data are then recorded; further, if f there is a pending URL, the file is downloaded containing the information shown in TABLE 12.

TABLE 12

| Name | Type | Required | Description |
|---|---|---|---|
| Id_Card | String | Required | Card Identifier |
| cardHash | String | Required | HMAC SHA 256 Hash calculated |
| | | | from card number and a given |
| | | | secret key. |
| lastFourDigits | Short | Required | Last 4 digits from bank card |
| | | | number. |
| updateType | Short | Required | Update Type (1-Create, 2- Delete) |
| updatedDate | Date | Required | Card update date. |

Here, new cards can be registered in the local repository, and the cards so indicated (for deletion) can be removed from the local repository. Additionally, the control figures or parameters can be consulted and compared periodically, to ensure that the information of the local repository is synchronized with that of the central repository. In case of any discrepancy, the system can proceed to request the data of the cards updated from the last date on which it is certain to have synchronized data. Here, the query methods that can be exposed through a REST Web Services can be GET to check if the card used in the transaction is registered, with additional query parameters shown in TABLE 13. Here, the responses to the foregoing request can include codes 200, 401, 404, and/or 500, wherein the response information can be further shown in TABLE 14.

TABLE 13

| Name | Type | Required | Description |
|---|---|---|---|
| cardHash | String | Required | HMAC SHA 256 Hash calculated from |
| | | | card number and a given secret key. |

TABLE 14

| Name | Type | Required | Description |
|---|---|---|---|
| requestId | string | Required | Request Identifier |
| cardHash | String | Required | HMAC SHA 256 Hash calculated |
| | | | from card number and a given |
| | | | secret key. |
| lastFourDigits | Short | Required | Last 4 digits from bank card |
| | | | number. |

In another embodiment, the card matching system of the disclosure described herein can include a JSON database feed. Here, the user or systems (such as the POS terminals, or third-party computing devices) using the system of the disclosure described herein can perform the card storing and matching processes by themselves, such as locally on the merchant's POS terminals or third party computing devices. In such an embodiment, the system of the disclosure described herein can send a JSON file (including the information from TABLE 12) with all of its user card information stored in its databases to the merchant's POS terminals or third party computing devices so that it can be replicated and managed locally by the merchant on its own systems, such as on its local POS terminals or computing devices. Next, the system can then feed the merchant's POS terminals or computing devices with periodic deltas of any changes performed to the card registry. Here, the rate in which deltas of information that can be sent can be configurable by each merchant/user. In particular, the merchant's POS terminals or computing devices can locally perform the card matching process disclosed with respect to FIG. 5 and further send the results of the search to the central server or repository of the disclosure described herein.

Here, the advantages and technical improvements of the disclosure described herein can include, among others, a secure, automated, and streamlined system for users to view all transactions made at various merchants for any given time period from a single portal or application system, thus ensuring accurate reporting of such transactions made by a user's credit card (or one or more preferred methods of payment). The automated system of the disclosure described herein not only reduces or eliminates human error in tracking, identifying, and managing transactions, but also requires minimal system resources from the associated servers, database, and POS terminals and minimal network bandwidth, thus improving the efficiency of such computing systems.

From the foregoing it will be seen that the present disclosure described herein is one well adapted to attain all ends and objectives herein-above set forth, together with the other advantages which are obvious and which are inherent to the invention.

Since many possible embodiments may be made of the invention without departing from the scope thereof, it is to be understood that all matters herein set forth or shown in the accompanying drawings are to be interpreted as illustrative, and not in a limiting sense.

While specific embodiments have been shown and discussed, various modifications may of course be made, and the invention is not limited to the specific forms or arrangement of parts described herein, except insofar as such limitations are included in following claims. Further, it will be understood that certain features and sub-combinations are of utility and may be employed without reference to other features and sub-combinations. This is contemplated by and is within the scope of the claims.

What is claimed is:

1. A method of matching a transaction between a customer and a merchant, the method comprising:
receiving payment information from a first user, wherein the payment information comprises an identifier associated with the first user;
generating a first hash of the identifier based on the received payment information from the first user and storing the first hash within a database;
receiving first transaction information at a point-of-sale terminal, wherein the first transaction information comprises the payment information from the first user including the identifier;
generating a second hash of the identifier based on the received transaction information; and
performing a search of the database to identify a match between the first hash and the second hash of the identifier associated with the first user.

2. The method of claim 1, wherein the identifier is comprised of a 16-digit credit card number.

3. The method of claim 2, further comprising:
retrieving second transaction information from the point-of-sale terminal.

4. The method of claim 3, wherein the second transaction information comprises one of more of: a transaction amount, approval number, merchant or establishment number, transaction number, or the last four-digits of the 16-digit credit card number.

5. The method of claim 4, further comprising:
generating a first string based on the second transaction information.

6. The method of claim 5, further comprising:
generating a third hash of the generated first string.

7. The method of claim 6, further comprising:
receiving the generated third hash;
generating a second string based on the second transaction information;
generating a fourth hash of the second string; and
receiving the generated fourth hash.

8. The method of claim 7, further comprising:
determining if the third hash matches the fourth hash.

9. The method of claim 8, further comprising:
upon determining that the third hash matches the fourth hash, performing a search of the repository to identify or locate either the last 4-digits of the identifier or the first or second hash of the identifier.

10. The method of claim 9, further comprising:
upon determining that the first user has been identified, sending a notification that the user has been identified and associating the first or second transaction information with the first user,

11. A system for matching a transaction between a customer and a merchant, comprising:
a memory storage storing computer-executable instructions; and
at least one processor communicatively coupled to the memory storage, wherein the at least one processor is configured to execute the instructions to:
receive payment information from a first user, wherein the payment information comprises an identifier associated with the first user;
generate a first hash of the identifier based on the received payment information from the first user;
receive first transaction information at a point-of-sale terminal, wherein the first transaction information comprises the payment information from the first user including the identifier;
generate a second hash of the identifier based on the received transaction information; and
perform a search of the repository to identify a match between the first hash and the second hash of the identifier associated with the first user.

12. The system of claim 11, wherein the identifier is comprised of a 16-digit credit card number.

13. The system of claim 12, wherein the at least one processor is configured to execute the instructions to:
retrieve second transaction information from the point-of-sale terminal.

14. The system of claim 13, wherein the second transaction information comprises one or more of: a transaction amount, approval number, merchant or establishment number, transaction number, and the last four-digits of the 16-digit credit card number.

15. The system of claim 14, wherein the at least one processor is configured to execute the instructions to:
generate a first string based on the second transaction information.

16. The system of claim 15, wherein the at least one processor is configured to execute the instructions to:
generate a third hash of the generated first string.

17. The system of claim 16, wherein the at least one processor is configured to execute the instructions to:
receive the generated third hash;
generate a second string based on the second transaction information;
generate a fourth hash of the second string; and
receive the generated fourth hash.

18. The system of claim 17, wherein the at least one processor is configured to execute the instructions to:
determine if the third hash matches the fourth hash.

19. The system of claim 18, wherein the at least one processor is configured to execute the instructions to:
upon determining that the third hash matches the fourth hash, perform a search of the repository to identify or locate either the last 4-digits of the identifier or the first or second hash of the identifier.

20. A non-transitory computer-readable recording medium having recorded thereon instructions executable by at least one processor to cause the at least one processor to perform a method for matching a transaction between a customer and a merchant, comprising:
receiving payment information from a first user, wherein the payment information comprises an identifier associated with the first user;
generating a first hash of the identifier based on the received payment information from the first user and storing the first hash within a database;
receiving first transaction information at a point-of-sale terminal, wherein the first transaction information comprises the payment information from the first user including the identifier;
generating a second hash of the identifier based on the received transaction information; and
performing a search of the database to identify a match between the first hash and the second hash of the identifier associated with the first user.
